(19) United States
(12) Patent Application Publication
(10) Pub. No.: US 2026/0186187 A1
(43) Pub. Date: Jul. 2, 2026

(54) LIGHT ABSORPTION ANISOTROPIC FILM AND LAMINATE

(71) Applicant: FUJIFILM Corporation, Tokyo (JP)

(72) Inventors: Shinichi YOSHINARI, Minamiashigara-shi (JP); Naoki KOITO, Minamiashigara-shi (JP); Naoya NISHIMURA, Minamiashigara-shi (JP)

(73) Assignee: FUJIFILM Corporation, Tokyo (JP)

(21) Appl. No.: 19/546,478

(22) Filed: Feb. 23, 2026

Related U.S. Application Data
(63) Continuation of application No. PCT/JP2024/030513, filed on Aug. 27, 2024.

(30) Foreign Application Priority Data
Sep. 27, 2023 (JP) 2023-165907

(51) Int. Cl. G02B 5/30

(52) U.S. Cl. CPC G02B 5/3016

(57) ABSTRACT

An object of the present invention is to provide a light absorption anisotropic film having a low haze value and a high alignment degree, and a laminate including the light absorption anisotropic film. The light absorption anisotropic film according to the embodiment of the present invention is a light absorption anisotropic film containing a dichroic substance, and a matrix consisting of all components other than the dichroic substance, in which at least one endothermic peak derived from the dichroic substance is observed by differential scanning calorimetry, and all of the endothermic peaks are endothermic peaks having an endothermic start temperature of 105° C. or higher.

### CROSS-REFERENCE TO RELATED APPLICATIONS

This application is a Continuation of PCT International Application No. PCT/JP2024/030513 filed on Aug. 27, 2024, which claims priority under 35 U.S.C. § 119(a) to Japanese Patent Application No. 2023-165907 filed on Sep. 27, 2023. The above applications are hereby expressly incorporated by reference, in their entirety, into the present application.

### BACKGROUND OF THE INVENTION

### 1. Field of the Invention

The present invention relates to a light absorption anisotropic film and a laminate.

### 2. Description of the Related Art

In order to prevent peeping into an image display device and control the viewing angle, a technique of using a light absorption anisotropic film having an absorption axis in the thickness direction is known.

For example, WO2022/270466A describes “an optical film including a light-absorbing anisotropic layer containing a liquid crystal compound and a dichroic substance, in which an angle θ between a transmittance central axis of the light-absorbing anisotropic layer and a normal direction of a surface of the light-absorbing anisotropic layer is 0° or more and 45° or less, and a haze value of the optical film is more than 1% and 20% or less”.

### SUMMARY OF THE INVENTION

As a result of studying the light-absorbing anisotropic layer (light absorption anisotropic film) included in the optical film described in WO2022/270466A, the present inventors have found that the haze value is high and the alignment degree can be improved.

Therefore, an object of the present invention is to provide a light absorption anisotropic film having a low haze value and a high alignment degree, and a laminate including the light absorption anisotropic film.

As a result of intensive studies to achieve the above object, the present inventors have found that a light absorption anisotropic film in which at least one endothermic peak derived from a dichroic substance is observed by differential scanning calorimetry (hereinafter, also referred to as “DSC”) and all endothermic start temperatures of the observed endothermic peaks are 105° C. or higher has a low haze value and a high alignment degree, and have completed the present invention.

That is, the present inventors have found that the above-described object can be achieved by employing the following configurations.
[1] A light absorption anisotropic film containing a dichroic substance, and a matrix consisting of all components other than the dichroic substance, in which at least one endothermic peak derived from the dichroic substance is observed by differential scanning calorimetry, and all of the endothermic peaks are endothermic peaks having an endothermic start temperature of 105° C. or higher, where the endothermic start temperature is a temperature at which a heat flow is 6% in a case where a heat flow at a peak top of the endothermic peak is set to 100% in a differential scanning calorimetry curve in which a vertical axis is a heat flow and a horizontal axis is a temperature, the temperature being lower than a temperature of the peak top of the endothermic peak.
[2] The light absorption anisotropic film according to [1], in which at least one endothermic peak derived from the matrix is observed by differential scanning calorimetry, and a peak top of an endothermic peak showing a maximum heat flow among the endothermic peaks is observed in a temperature range of 108° C. or higher.
[3] The light absorption anisotropic film according to [1] or [2], in which an absolute value of a difference between a log P value of the dichroic substance and a log P value of the matrix is 4.8 to 5.8.
[4] The light absorption anisotropic film according to any one of [1] to [3], in which an angle θ between a transmittance central axis of the light absorption anisotropic film and a normal direction of a surface of the light absorption anisotropic film is 0° or more and 45° or less.
[5] The light absorption anisotropic film according to any one of [1] to [4], in which the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.
[6] A laminate including the light absorption anisotropic film according to any one of [1] to [5].

According to the present invention, it is possible to provide a light absorption anisotropic film having a low haze value and a high alignment degree, and a laminate including the light absorption anisotropic film.

### BRIEF DESCRIPTION OF THE DRAWINGS

FIG. 1 is a schematic view showing an example of a head-mounted display (hereinafter, also referred to as a “head-mounted display of the present invention”) having a laminate of the present invention.

FIG. 2 is a schematic diagram showing an example of a configuration of a light guide plate for an augmented reality (AR) glass.

FIG. 3 is a schematic diagram showing a plan view of an evaluation system of a head-mounted display according to the present invention.

FIG. 4 shows a DSC curve of the light absorption anisotropic film prepared in Example 1.

FIG. 5 shows a DSC curve of the light absorption anisotropic film prepared in Comparative Example 1.

FIG. 6 shows a DSC curve of only the matrix included in the light absorption anisotropic film prepared in Example 1 and Comparative Example 1.

### DESCRIPTION OF THE PREFERRED EMBODIMENTS

Hereinafter, the present invention will be described in detail.

The following description of configuration requirements is based on representative embodiments of the present invention, but the present invention is not limited to the embodiments.

In the present specification, a numerical range expressed using “to” means a range including numerical values before and after “to” as a lower limit value and an upper limit value.

In addition, in the present specification, an upper limit value or a lower limit value described in a certain numerical range in a numerical range described in a stepwise manner may be replaced with an upper limit value or a lower limit value in another numerical range described in a stepwise manner. In addition, regarding the numerical range described in the present specification, an upper limit value or a lower limit value described in a numerical value may be replaced with a value described in Examples.

In addition, in the present specification, substances corresponding to respective components may be used alone or in combination of two or more kinds thereof.

Here, in a case where two or more kinds of substances are used in combination for each component, the content of the component indicates the total content of the substances used in combination, unless otherwise specified. In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

### [Light Absorption Anisotropic Film]

The light absorption anisotropic film according to the present invention contains a dichroic substance and a matrix consisting of all components other than the dichroic substance.

In addition, the light absorption anisotropic film according to the present invention is a light absorption anisotropic film in which at least one endothermic peak derived from the dichroic substance is observed by differential scanning calorimetry, and all of the endothermic peaks derived from the dichroic substance (in a case where only one endothermic peak is observed, the observed one endothermic peak) are endothermic peaks having an endothermic start temperature of 105° C. or higher.

Here, the differential scanning calorimetry is performed by using a differential scanning calorimetry device (for example, X-DSC7000 manufactured by Seiko Instruments Inc.) to measure a sample of 3.0 mg±0.3 mg of the light absorption anisotropic film in an aluminum sample pan while heating from room temperature to 140° C. at a rate of 5° C./min in a nitrogen atmosphere.

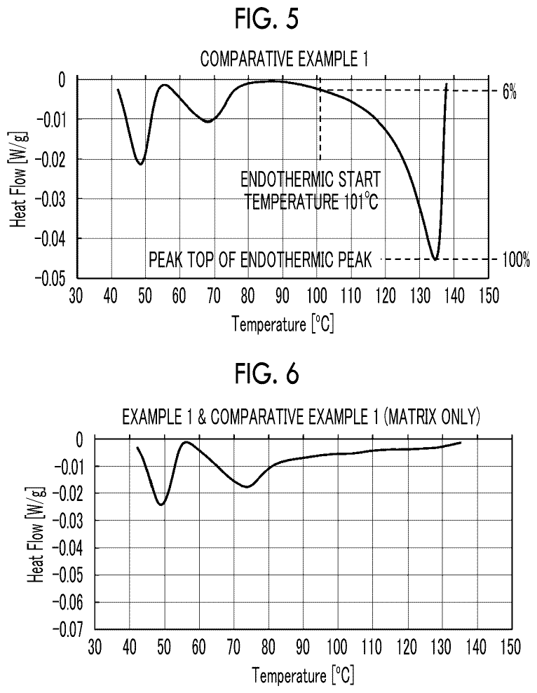

In addition, the endothermic start temperature is a temperature at which a heat flow is 6% in a case where a heat flow at a peak top of the endothermic peak is set to 100% in a differential scanning calorimetry curve (hereinafter, also referred to as a “DSC curve”) in which a vertical axis is a heat flow (hereinafter, in FIGS. 4 to 6, “Heat Flow”) and a horizontal axis is a temperature, and is lower than a temperature of the peak top of the endothermic peak. Specifically, as shown in FIG. 4, in Example 1 described below, the temperature at which the heat flow is 6% in a case where the heat flow at the peak top of the endothermic peak is set to 100% is 108° C., but as shown in FIG. 5, in Comparative Example 1 described below, the temperature at which the heat flow is 6% in a case where the heat flow at the peak top of the endothermic peak is set to 100% is 101° C.

In the present invention, the light absorption anisotropic film in which the endothermic peak derived from the dichroic substance is observed by DSC and all endothermic start temperatures of the observed endothermic peaks are 105° C. or higher has a low haze value and a high alignment degree.

The reason why this effect is exhibited is not clear in detail, but the present inventors have presumed as follows.

First, it is considered that the dichroic substance constitutes various aggregates (for example, in a state of crystals, co-crystals, and aggregates) in the light absorption anisotropic film.

Therefore, the endothermic start temperature of the endothermic peak derived from the dichroic substance corresponds to the endothermic of the most unstable aggregate, and the fact that the endothermic start temperature is high indicates that the most unstable aggregate is relatively stable. Then, the degree of stability can be used as an indicator of the strength of the attraction between the dichroic substances or the regularity of the alignment.

Therefore, it is considered that the light absorption anisotropic film in which the endothermic start temperature of all of the endothermic peaks derived from the dichroic substance is 105° C. or higher has a high alignment degree, and the haze value is low because ideal microcrystals are easily formed and coarse particles are reduced.

As described above, in the light absorption anisotropic film according to the present invention, the endothermic start temperature of all of the endothermic peaks derived from the dichroic substance is 105° C. or higher, preferably 108° C. or higher, and the upper limit value of the endothermic start temperature is preferably 140° C. or lower.

Since the haze value is further reduced, the light absorption anisotropic film according to the present invention is preferably a light absorption anisotropic film in which at least one endothermic peak derived from the matrix is observed by DSC and a peak top (hereinafter also referred to as “maximum endothermic peak temperature of the matrix”) of an endothermic peak showing a maximum heat flow among the endothermic peaks (in a case where a plurality of endothermic peaks are observed, it means an endothermic peak showing a maximum heat flow among all the endothermic peaks, and in a case where only one endothermic peak is observed, it means the observed one endothermic peak) is observed in a temperature range of 108° C. or higher, and it is more preferably a light absorption anisotropic film in which the endothermic peak showing a maximum heat flow among the endothermic peaks is observed in a temperature range of 109° C. or higher. The upper limit value of the temperature range is preferably 140° C. or lower.

Here, it is possible to determine whether the observed endothermic peak is derived from the dichroic substance or derived from the matrix as follows.

First, in a case where each material constituting the light absorption anisotropic film is available, as in Examples described below, a film consisting only of materials other than the dichroic substance, that is, a film consisting only of the matrix is prepared, the DSC of the film is measured, and the endothermic peak of the matrix and the endothermic peak of the dichroic substance can be discriminated from each other by comparing the DSC measurement result of the light absorption anisotropic film containing the dichroic substance and the matrix.

In addition, in a case where the endothermic peak of the matrix and the endothermic peak of the dichroic substance overlap with each other, a different matrix having an endothermic peak sufficiently lower than the endothermic peak of the dichroic substance (the endothermic peaks do not overlap with each other) is prepared, a light absorption anisotropic film consisting of the matrix and the dichroic substance is prepared, and the endothermic peak of the dichroic substance can be measured.

On the other hand, in a case where only the light absorption anisotropic film is available, the light absorption anisotropic film is crushed as finely as possible, and the DSC measurement is performed on each of the light absorption anisotropic film prepared from a sample in which only the dichroic substance is extracted and removed by a solvent or the like and the powder of only the matrix remaining without being extracted. By comparing these results with the DSC measurement result of the light absorption anisotropic film before extraction (that is, the obtained light absorption anisotropic film), the endothermic peak of the matrix and the endothermic peak of the dichroic substance can be discriminated from each other.

In addition, as in the above-described case, in a case where the endothermic peak of the matrix and the endothermic peak of the dichroic substance overlap with each other, a different matrix having an endothermic peak sufficiently lower than the endothermic peak of the dichroic substance is prepared, a light absorption anisotropic film consisting of the matrix and the dichroic substance obtained by the above-described extraction is prepared, and the endothermic peak of the dichroic substance can be measured. Alternatively, for the coloring agent obtained by extraction, a molecular structure may be identified by a known method such as nuclear magnetic resonance (NMR), infrared absorption spectrometry (IR), and mass spectrometry, a dichroic substance having the same molecular structure may be synthesized, a light absorption anisotropic film may be prepared by combining the dichroic substance with the matrix, and the endothermic peak may be measured by DSC.

Since the alignment degree is further increased, in the light absorption anisotropic film according to the present invention, an absolute value of a difference between a log P value of the dichroic substance and a log P value of the matrix (hereinafter, also referred to as “Δ log P value”) is preferably 4.8 to 5.8.

Here, the log P value is an index for expressing properties of hydrophilicity and hydrophobicity of a chemical structure, and is also referred to as a hydrophilic-hydrophobic parameter. The log P value can be calculated using software such as ChemBioDraw Ultra or HSPiP (Ver. 4.1.07). In addition, the log P value can be acquired experimentally by the method of the OECD Guidelines for the Testing of Chemicals, Sections 1, Test No. 117, or the like. In the present invention, a value calculated by inputting the structural formula of a compound to HSPiP (Ver. 4.1.07) is adopted as the log P value unless otherwise specified.

In addition, the log P value of the matrix can be calculated as a value obtained by calculating the log P value for each component other than the dichroic substance and performing a weighted average based on the addition ratio on a mass basis. In a case where a low-molecular-weight liquid crystal compound is contained in the liquid crystal composition for forming the light absorption anisotropic film, the log P value of a component derived from the low-molecular-weight liquid crystal compound contained in the light absorption anisotropic film can be set to the log P value of the low-molecular-weight liquid crystal compound contained in the liquid crystal composition.

Since the effect of the present invention that the haze value is low and the alignment degree is high is exhibited, in the light absorption anisotropic film according to the present invention, an angle θ (hereinafter, also referred to as “transmittance central axis angle θ”) between the transmittance central axis of the light absorption anisotropic film and the normal direction of the surface of the light absorption anisotropic film is preferably 0° or more and 45° or less, more preferably 0° or more and less than 45°, still more preferably 0° or more and 35° or less, and particularly preferably 0° or more and less than 35°.

Here, the transmittance central axis of the light absorption anisotropic film means a direction in which the highest transmittance is exhibited in a case where the transmittance is measured by changing a tilt angle (polar angle) and a tilt direction (azimuthal angle) with respect to the normal direction of the surface (main surface) of the light absorption anisotropic film.

Specifically, the Mueller matrix at a wavelength of 550 nm is measured using AxoScan (OPMF-2, manufactured by Axometrics, Inc.). More specifically, in the measurement, the azimuthal angle at which the transmittance central axis is inclined is first searched for, the Mueller matrix at a wavelength of 550 nm is measured while the polar angle which is the angle with respect to the surface of the light absorption anisotropic film in the normal direction is changed from −70° to 70° at intervals of 1° in the surface (the plane which has the transmittance central axis and is orthogonal to the film surface) having the normal direction of the light absorption anisotropic film along the azimuthal angle thereof, and the transmittance of the light absorption anisotropic film is derived. As a result, the direction in which the highest transmittance is exhibited is defined as the transmittance central axis.

The transmittance central axis denotes a direction of an absorption axis (major axis direction of a molecule) of the dichroic substance contained in the light absorption anisotropic film.

It is preferable that the light absorption anisotropic film according to the present invention is a film obtained by immobilizing an alignment state of a liquid crystal composition containing a liquid crystal compound, a dichroic substance, and the like.

Hereinafter, components contained in the liquid crystal composition will be described in detail.

Each component described below is basically a component contained in the light absorption anisotropic film, but a component having a crosslinkable group (including a polymerizable group) is contained in the light absorption anisotropic film as a crosslinked (polymerized) component for reasons such as immobilization of the alignment state.

### <Liquid Crystal Compound>

The liquid crystal composition contains a liquid crystal compound. In this manner, the dichroic substance can be aligned with a higher alignment degree while the precipitation of the dichroic substance is suppressed.

Both a polymer liquid crystal compound and a low-molecular-weight liquid crystal compound can be used as the liquid crystal compound, and a polymer liquid crystal compound is preferable from the viewpoint that the alignment degree can be increased. Further, a polymer liquid crystal compound and a low-molecular-weight liquid crystal compound may be used in combination as the liquid crystal compound.

Here, the “polymer liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the polymer liquid crystal compound include thermotropic liquid crystal polymers described in JP2011-237513A and polymer liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A, and among these, a liquid crystal compound exhibiting smectic properties is preferable.

Examples of such a liquid crystal compound include compounds described in paragraphs [0019] to [0140] of WO2022/014340A, the description of which is incorporated herein by reference.

It is preferable that the liquid crystal compound is a liquid crystal compound that does not exhibit dichroism in a visible light region.

A content of the liquid crystal compound is preferably 25 to 2,000 parts by mass, more preferably 100 to 1,300 parts by mass, and still more preferably 200 to 900 parts by mass with respect to 100 parts by mass of the dichroic substance described below. In a case where the content of the liquid crystal compound is within the above-described range, the alignment degree of the dichroic substance is further improved.

The light absorption anisotropic film may contain only one or two or more kinds of liquid crystal compounds. In a case where the light absorption anisotropic film contains two or more kinds of liquid crystal compounds, the content of the liquid crystal compounds denotes the total content of the liquid crystal compounds.

### <Dichroic Substance>

The liquid crystal composition contains a dichroic substance.

Here, the dichroic substance means a coloring agent having different absorbances depending on the direction.

In addition, the dichroic substance may or may not exhibit liquid crystallinity.

The dichroic substance is not particularly limited, and examples thereof include a visible light absorbing substance (dichroic coloring agent), a light emitting substance (fluorescent substance and phosphorescent substance), an ultraviolet absorbing substance, an infrared absorbing substance, a non-linear optical substance, a carbon nanotube, and an inorganic substance (for example, quantum rod). Further, known dichroic substances (dichroic coloring agents) of the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the dichroic substance, a dichroic azo coloring agent compound is preferable. The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, any of nematic properties or smectic properties may be exhibited. The temperature range in which the liquid crystal phase is exhibited is preferably room temperature (approximately 20° C. to 28° C.) to 300° C., and from the viewpoint of handleability and manufacturing suitability, more preferably 50° C. to 200° C.

In the present invention, from the viewpoint of adjusting the tint, as the dichroic substance, it is preferable to use a mixture including at least a coloring agent compound (particularly, a dichroic azo coloring agent compound) having a maximal absorption wavelength in a wavelength range of 380 nm or more and less than 455 nm, a coloring agent compound (particularly, a dichroic azo coloring agent compound) having a maximal absorption wavelength in a wavelength range of 455 nm or more and less than 560 nm, and a coloring agent compound (particularly, a dichroic azo coloring agent compound) having a maximal absorption wavelength in a wavelength range of 560 nm or more and 700 nm or less.

In particular, in the present invention, it is preferable to contain a dichroic azo coloring agent compound represented by Formula (1) as the coloring agent compound having a maximal absorption wavelength in a wavelength range of 380 nm or more and less than 455 nm.

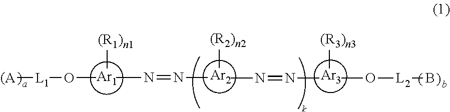

In Formula (1), A and B each independently represent a crosslinkable group.

In Formula (1), a and b each independently represent 0 or 1. Provided that a+b≥1 is satisfied.

In Formula (1), in a case where a is 0, L₁ represents a monovalent substituent, and in a case where a is 1, L₁ represents a single bond or a divalent linking group. In addition, L₂ represents a monovalent substituent in a case where b is 0, and L₂ represents a single bond or a divalent linking group in a case where b is 1.

In Formula (1), Ar₁ represents an (n1+2)-valent aromatic hydrocarbon group or heterocyclic group, Ar₂ represents an (n2+2)-valent aromatic hydrocarbon group or heterocyclic group, and Ar₃ represents an (n3+2)-valent aromatic hydrocarbon group or heterocyclic group.

In Formula (1), R₁, R₂, and R₃ each independently represent a monovalent substituent. A plurality of R₁'s may be the same or different from each other in a case of “n1≥2”, a plurality of R₂'s may be the same or different from each other in a case of “n2≥2”, and a plurality of R₃'s may be the same or different from each other in a case of “n3≥2”.

In Formula (1), k represents an integer of 1 to 4. In a case of “k≥2”, a plurality of Ar₂'s may be the same or different from each other, and a plurality of R₂'s may be the same or different from each other.

In Formula (1), n1, n2, and n3 each independently represent an integer of 0 to 4. Provided that, an expression of “n1+n2+n3≥0” is satisfied in a case of “k=1”, and an expression of “n1+n2+n3≥1” is satisfied in a case of “k≥2”.

For the description and examples of each symbol in Formula (1), examples thereof include those described in paragraphs [0013] to [0038] of WO2017/195833A, the description of which is incorporated herein by reference.

In the present invention, since it is easy to observe at least one endothermic peak derived from the dichroic substance having an endothermic start temperature of 105° C. or higher, the dichroic azo coloring agent compound represented by Formula (1) is preferably a compound in which a and b in Formula (1) both represent 1, k represents 1 or 2, n1 and n3 both represent 1, n2 represents 0 or 1, Ar₁ to Ar₃ in Formula (1) all represent a phenylene group, R₁ and R₃ both represent a halogen atom (particularly, chlorine) at an ortho position of an azo bond (—N═N—), R₂ represents an alkyl group (particularly, a methyl group) in a case where n2 is 1, L₁ and L₂ both represent an alkylene group having 2 to 6 carbon atoms, and A and B both represent a (meth)acryloyloxy group.

The content of the dichroic substance contained in the light absorption anisotropic film is not particularly limited, but from the viewpoint of increasing the alignment degree of the light absorption anisotropic film to be formed, the content is preferably 3% by mass or more, more preferably 8% by mass or more, still more preferably 10% by mass or more, and particularly preferably 10% to 30% by mass with respect to the total mass of the light absorption anisotropic film. In a case where a plurality of dichroic substances are used in combination, the total amount of the plurality of dichroic substances is preferably within the above range.

In addition, from the viewpoint of increasing the alignment degree of the light absorption anisotropic film to be formed, the content of the dichroic substance contained in the light absorption anisotropic film is preferably 20 to 650 mg/cm³, more preferably 25 to 500 mg/cm³, still more preferably 30 to 200 mg/cm³, and even still more preferably 40 to 150 mg/cm³. In a case where a plurality of dichroic substances are used in combination, the total amount of the plurality of dichroic substances is preferably within the above range.

Here, the content (mg/cm³) of the dichroic substance is obtained by measuring a solution in which a laminate including the light absorption anisotropic film is dissolved, or an extraction liquid obtained by immersing the laminate in a solvent, using high performance liquid chromatography (HPLC); but the measurement method is not limited to the above-described method. In addition, the quantification can be performed by using the dichroic substance contained in the light absorption anisotropic film as a standard sample.

Examples of the method of calculating the content of the dichroic substance include a method in which the volume is calculated by multiplying the thickness of the light absorption anisotropic film obtained from a microscopic observation image of a cross section of the laminate by the area of the laminate used for measuring the coloring agent amount, and is divided by the coloring agent amount measured by HPLC to calculate the content of the coloring agent.

### <Vertical Alignment Agent>

It is preferable that the liquid crystal composition contains a vertical alignment agent.

Here, the vertical alignment agent refers to an additive having a function of aligning the above-described liquid crystal compound in a direction perpendicular to the main plane of the light absorption anisotropic film. The term “aligning in a direction perpendicular to” does not require the alignment at exactly 90°, but means the alignment at 70° to 110°.

Examples of the vertical alignment agent include an ionic vertical alignment agent and a vertical alignment agent having a boronic acid group; and it is preferable to use an ionic vertical alignment agent and a vertical alignment agent having a boronic acid group in combination.

Suitable examples of the ionic vertical alignment agent include an onium compound represented by Formula (B1).

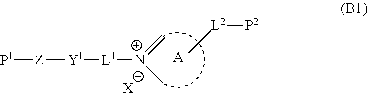

In Formula (B1), a ring A represents a quaternary ammonium ion consisting of a nitrogen-containing heterocyclic ring.

In addition, X represents an anion.

In addition, L¹ represents a divalent linking group.

In addition, L² represents a single bond or a divalent linking group.

In addition, Y¹ represents a divalent linking group having a 5-membered ring or a 6-membered ring as a partial structure.

In addition, Z represents a divalent linking group having an alkylene group having 2 to 20 carbon atoms as a partial structure.

In addition, P¹ and P² each independently represent a monovalent substituent having a polymerizable ethylenically unsaturated bond.

The ring A represents a quaternary ammonium ion consisting of a nitrogen-containing heterocyclic ring. Examples of the ring A include a pyridine ring, a picoline ring, a 2,2′-bipyridyl ring, a 4,4′-bipyridyl ring, a 1,10-phenanthroline ring, a quinoline ring, an oxazole ring, a thiazole ring, an imidazole ring, a pyrazine ring, a triazole ring, and a tetrazole ring, and the ring A is preferably a quaternary imidazolium ion or a quaternary pyridinium ion.

X represents an anion. Examples of X include a halogen anion (for example, a fluorine ion, a chlorine ion, a bromine ion, an iodine ion, and the like), a sulfonate ion (for example, a methanesulfonate ion, a trifluoromethanesulfonate ion, a methylsulfate ion, a vinylsulfonate ion, an allylsulfonate ion, a p-toluenesulfonate ion, a p-chlorobenzenesulfonate ion, a p-vinylbenzenesulfonate ion, a 1,3-benzenedisulfonate ion, a 1,5-naphthalenedisulfonate ion, a 2,6-naphthalenedisulfonate ion, and the like), a sulfate ion, a carbonate ion, a nitrate ion, a thiocyanate ion, a perchlorate ion, a tetrafluoroborate ion, a picrate ion, an acetate ion, a benzoate ion, a p-vinyl benzoate ion, a formate ion, a trifluoroacetate ion, a phosphate ion (for example, hexafluorophosphate ion), and a hydroxide ion. X is preferably a halogen anion, a sulfonate ion, or a hydroxide ion. In addition, a chlorine ion, a bromine ion, an iodine ion, a methanesulfonate ion, a vinylsulfonate ion, a p-toluenesulfonate ion, or a p-vinylbenzenesulfonate ion is particularly preferable.

L¹ represents a divalent linking group. Examples of L¹ include a divalent linking group having 1 to 20 carbon atoms, consisting of a combination of an alkylene group, —O—, —S—, —CO—, —SO₂—, —NRa— (here, Ra is an alkyl group having 1 to 5 carbon atoms or a hydrogen atom), an alkenylene group, an alkynylene group, and an arylene group. L¹ is preferably -AL-, —O-AL-, —CO—O-AL-, or —O—CO-AL-, each of which has 1 to 10 carbon atoms, more preferably -AL- or —O-AL-, each of which has 1 to 10 carbon atoms, and most preferably -AL- or —O-AL-, each of which has 1 to 5 carbon atoms. AL represents an alkylene group.

L² represents a single bond or a divalent linking group. Examples of L² include a divalent linking group having 1 to 10 carbon atoms, consisting of a combination of an alkylene group, —O—, —S—, —CO—, —SO₂—, —NRa— (here, Ra is an alkyl group having 1 to 5 carbon atoms or a hydrogen atom), an alkenylene group, an alkynylene group, and an arylene group; a single bond, —O—, —O—CO—, —CO—O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, and —O—CO-AL-CO—O—. AL represents an alkylene group. L² is preferably a single bond, -AL-, —O-AL-, or —NRa-AL-O—, each of which has 1 to 10 carbon atoms, more preferably a single bond, -AL-, —O-AL-, or —NRa-AL-O—, each of which has 1 to 5 carbon atoms, and most preferably a single bond, —O-AL-, or —NRa-AL-O—, each of which has 1 to 5 carbon atoms.

Y¹ represents a divalent linking group having a 5- or 6-membered ring as a partial structure. Examples of Y¹ include a cyclohexyl ring, an aromatic ring, or a heterocyclic ring. Examples of the aromatic ring include a benzene ring, an indene ring, a naphthalene ring, a fluorene ring, a phenanthrene ring, an anthracene ring, a biphenyl ring, and a pyrene ring, and a benzene ring, a biphenyl ring, or a naphthalene ring is particularly preferable. As a heteroatom constituting the heterocyclic ring, a nitrogen atom, an oxygen atom, or a sulfur atom is preferable, and examples of the heterocyclic ring include a furan ring, a thiophene ring, a pyrrole ring, a pyrroline ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring, and a triazine ring. The heterocyclic ring is preferably a 6-membered ring. The divalent linking group represented by Y¹, having a 5- or 6-membered ring as a partial structure, may further have a substituent (for example, the above-described substituent W).

The divalent linking group represented by Y¹ is preferably a divalent linking group having two or more 5- or 6-membered rings, and more preferably has a structure in which two or more rings are linked to each other through a linking group. Examples of the linking group include the examples of the linking group represented by L¹ and L², —C≡C—, —CH═CH—, —CH═N—, —N═CH—, and —N═N—.

Z represents a divalent linking group which has an alkylene group having 2 to 20 carbon atoms as a partial structure and consists of a combination of —O—, —S—, —CO—, and —SO₂—, in which the alkylene group may have a substituent. Examples of the above-described divalent linking group include an alkyleneoxy group and a polyalkyleneoxy group. The number of carbon atoms in the alkylene group represented by Z is more preferably 2 to 16, still more preferably 2 to 12, and particularly preferably 2 to 8.

P1 and P2 each independently represent a monovalent substituent having a polymerizable ethylenically unsaturated group. Examples of the above-described monovalent substituent having a polymerizable ethylenically unsaturated group include Formulae (M-1) to (M-8). That is, the monovalent substituent having a polymerizable ethylenically unsaturated group may be a substituent consisting of only an ethenyl group as in Formula (M-8).

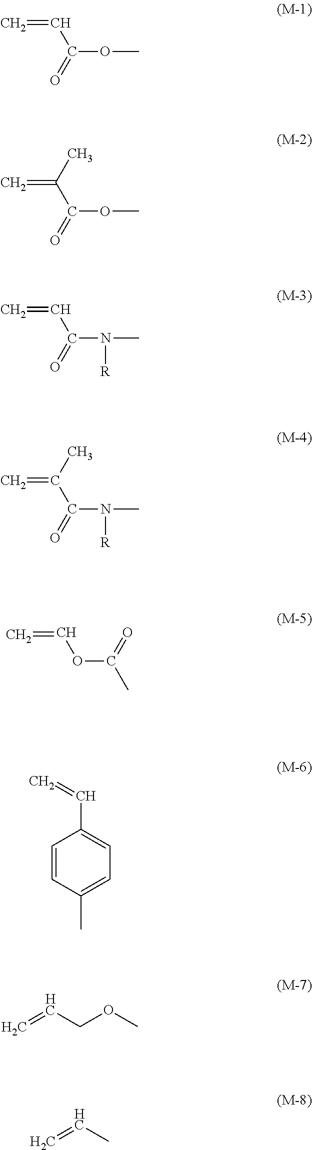

In Formulae (M-3) and (M-4), R represents a hydrogen atom or an alkyl group, and a hydrogen atom or a methyl group is preferable. Among Formulae (M-1) to (M-8), (M-1), (M-2), or (M-8) is preferable, and (M-1) or (M-8) is more preferable. In particular, P1 is preferably (M-1). In addition, P2 is preferably (M-1) or (M-8), and in a compound in which the ring A is quaternary imidazolium ion, P2 is preferably (M-8) or (M-1), and in a compound in which the ring A is a quaternary pyridinium ion, P2 is preferably (M-1).

Examples of the onium compound represented by Formula (B1) include onium salts described in paragraphs 0052 to 0058 of JP2012-208397A, onium salts described in paragraphs 0024 to 0055 of JP2008-026730A, and onium salts described in JP2002-37777A.

Examples of the ionic vertical alignment agent include those described in paragraphs [0017] to [0029] of JP2020-181150A, in addition to the onium compound represented by Formula (B1).

Suitable examples of the vertical alignment agent having a boronic acid group include a boronic acid compound represented by Formula (B2).

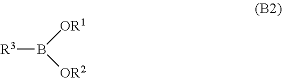

In Formula (B2), R¹ and R² each independently represent a hydrogen atom, an aliphatic hydrocarbon group which may have a substituent, an aryl group which may have a substituent, or a heterocyclic group which may have a substituent.

In addition, R³ represents a substituent.

Examples of the aliphatic hydrocarbon group represented by one aspect of R¹ and R² include a linear or branched alkyl group having 1 to 20 carbon atoms, which may be substituted or unsubstituted, (for example, a methyl group, an ethyl group, an iso-propyl group, and the like), a substituted or unsubstituted cyclic alkyl group having 3 to 20 carbon atoms (for example, a cyclohexyl group and the like), and an alkenyl group having 2 to 20 carbon atoms (for example, a vinyl group and the like).

In addition, examples of the aryl group represented by one aspect of R¹ and R² include a substituted or unsubstituted phenyl group having 6 to 20 carbon atoms (for example, a phenyl group, a tolyl group, and the like), and a substituted or unsubstituted naphthyl group having 10 to 20 carbon atoms.

In addition, examples of the heterocyclic group represented by one aspect of R¹ and R² include a substituted or unsubstituted 5-membered or 6-membered ring group including at least one heteroatom (for example, a nitrogen atom, an oxygen atom, a sulfur atom, and the like), and specific examples thereof include a pyridyl group, an imidazolyl group, a furyl group, a piperidyl group, and a morpholino group.

R¹ and R² may be linked to each other to form a ring. For example, isopropyl groups of R¹ and R² may be linked to each other to form a 4,4,5,5-tetramethyl-1,3,2-dioxaborolane ring.

As R¹ and R², a hydrogen atom, a linear or branched alkyl group having 1 to 3 carbon atoms, or an aspect in which these groups are linked to each other to form a ring is preferable, and a hydrogen atom is more preferable.

As the substituent represented by R³, a substituent including a functional group which can be bonded to a (meth)acrylic group is preferable.

Here, examples of the functional group which can be bonded to a (meth)acrylic group include a vinyl group, an acrylate group, a methacrylate group, an acrylamide group, a styryl group, a vinyl ketone group, a butadiene group, a vinyl ether group, an oxiranyl group, an aziridinyl group, and an oxetane group. Among these, a vinyl group, an acrylate group, a methacrylate group, a styryl group, an oxiranyl group, or an oxetane group is preferable, and a vinyl group, an acrylate group, an acrylamide group, or a styryl group is more preferable.

R³ is preferably a substituted or unsubstituted aliphatic hydrocarbon group, aryl group, or heterocyclic group having the functional group which can be bonded to a (meth)acrylic group.

Examples of the aliphatic hydrocarbon group include a substituted or unsubstituted linear or branched alkyl group having 1 to 30 carbon atoms (for example, a methyl group, an ethyl group, an iso-propyl group, an n-propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an sec-butyl group, a tert-butyl group, an isopentyl group, a neopentyl group, a 1-methylbutyl group, an isohexyl group, a 2-methylhexyl group, and the like), a substituted or unsubstituted cyclic alkyl group having 3 to 20 carbon atoms (for example, a cyclopentyl group, a cyclohexyl group, a 1-adamantyl group, a 2-norbornyl group, and the like), and an alkenyl group having 2 to 20 carbon atoms (for example, a vinyl group, a 1-propenyl group, a 1-butenyl group, a 1-methyl-1-propenyl group, and the like).

Examples of the aryl group include a substituted or unsubstituted phenyl group having 6 to 50 carbon atoms (for example, a phenyl group, a tolyl group, a styryl group, a 4-benzoyloxyphenyl group, a 4-phenoxycarbonylphenyl group, a 4-biphenyl group, a 4-(4-octyloxybenzoyloxy)phenoxycarbonylphenyl group, and the like), and a substituted or unsubstituted naphthyl group having 10 to 50 carbon atoms (for example, an unsubstituted naphthyl group and the like).

The heterocyclic group is, for example, a substituted or unsubstituted 5-membered or 6-membered ring group including at least one heteroatom (for example, a nitrogen atom, an oxygen atom, a sulfur atom, and the like), and examples thereof include groups of pyrrole, furan, thiophene, pyrazole, imidazole, triazole, oxazole, isoxazole, oxadiazole, thiazole, thiadiazole, indole, carbazole, benzofuran, dibenzofuran, thianaphthene, dibenzothiophene, indazole, benzimidazole, anthranil, benzisoxazole, benzoxazole, benzothiazole, purine, pyridine, pyridazine, pyrimidine, pyrazine, triazine, quinoline, acridine, isoquinoline, phthalazine, quinazoline, quinoxaline, naphthyridine, phenanthroline, pteridine, morpholine, and piperidine, and the like.

Examples of the boronic acid compound represented by Formula (B2) include a boronic acid compound represented by General Formula (I) described in paragraphs 0023 to 0032 of JP2008-225281A.

As the compound represented by Formula (B2), compounds exemplified below are also preferable.

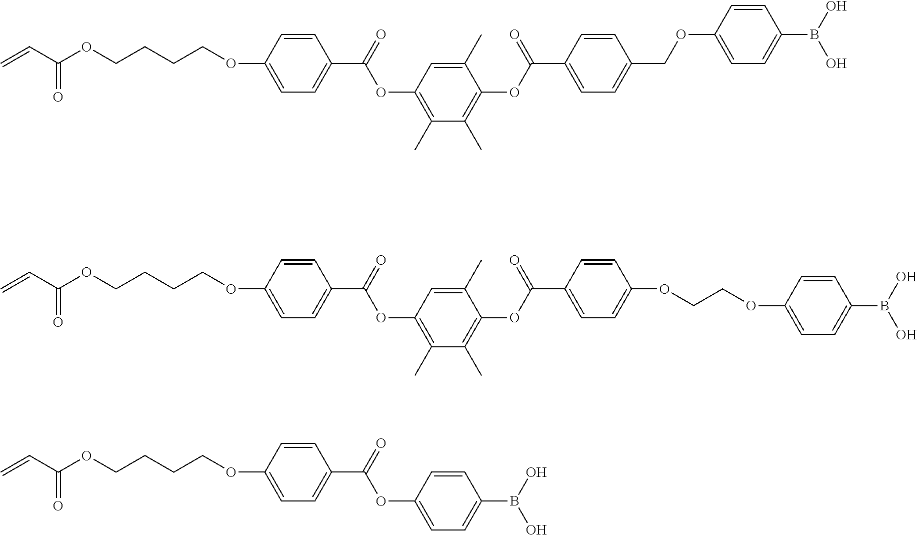 [SMILES: C=CC(=O)OCCCCOc1ccc(C(=O)Oc2cc(C)c(OC(=O)c3ccc(COc4ccc(B(O)O)cc4)cc3)c(C)c2C)cc1 ; C=CC(=O)OCCCCOc1ccc(C(=O)Oc2cc(C)c(OC(=O)c3ccc(OCCOc4ccc(B(O)O)cc4)cc3)c(C)c2C)cc1 ; C=CC(=O)OCCCCOc1ccc(C(=O)Oc2ccc(B(O)O)cc2)cc1]

In a case where the liquid crystal composition contains a vertical alignment agent, a content of the vertical alignment agent is preferably 1.0 to 7.0 parts by mass, more preferably 1.5 to 8.0 parts by mass, and still more preferably 2.5 to 6.0 parts by mass with respect to 100 parts by mass of the liquid crystal compound.

The liquid crystal composition may include only one kind of the vertical alignment agent, or may include two or more kinds thereof. In a case where the liquid crystal composition contains two or more kinds of liquid crystal compounds, the content of the vertical alignment agent means the total content of the vertical alignment agents.

### <Solvent>

From the viewpoint of workability and the like, it is preferable that the liquid crystal composition described above contains a solvent.

Examples of the solvent include organic solvents such as ketones (such as acetone, 2-butanone, methyl isobutyl ketone, cyclopentanone, cyclohexanone, and acetylacetone), ethers (such as dioxane, tetrahydrofuran, tetrahydropyran, dioxolane, tetrahydrofurfuryl alcohol, cyclopentyl methyl ether, and dibutyl ether), aliphatic hydrocarbons (such as hexane), alicyclic hydrocarbons (such as cyclohexane), aromatic hydrocarbons (such as benzene, toluene, xylene, tetralin, and trimethylbenzene), halogenated carbons (such as dichloromethane, trichloromethane (chloroform), dichloroethane, dichlorobenzene, 1,1,2,2-tetrachloroethane, and chlorotoluene), esters (such as methyl acetate, ethyl acetate, butyl acetate, diethyl carbonate, ethyl acetoacetate, n-pentyl acetate, ethyl benzoate, benzyl benzoate, butyl carbitol acetate, diethylene glycol monoethyl ether acetate, and isoamyl acetate), alcohols (such as ethanol, isopropanol, butanol, cyclohexanol, furfuryl alcohol, 2-ethylhexanol, octanol, benzyl alcohol, ethanolamine, ethylene glycol, propylene glycol, diethylene glycol, diethylene glycol monomethyl ether, diethylene glycol monoethyl ether, and diethylene glycol monobutyl ether), phenols (such as phenol and cresol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine and 2,6-lutidine); and water.

These solvents may be used alone or in combination of two or more kinds thereof.

In a case where the liquid crystal composition described above contains a solvent, a content of the solvent is preferably 60% to 99.5% by mass, more preferably 70% to 99% by mass, and particularly preferably 75% to 98% by mass with respect to the total mass (100% by mass) of the liquid crystal composition.

### <Polymerization Initiator>

The liquid crystal composition described above may contain a polymerization initiator.

The polymerization initiator is not particularly limited, but a compound having photosensitivity, that is, a photopolymerization initiator is preferable.

As the photopolymerization initiator, various compounds can be used without any particular limitation. Examples of the photopolymerization initiator include a-carbonyl compounds (U.S. Pat. Nos. 2,367,661A and 2,367,670A), acyloin ether (U.S. Pat. No. 2,448,828A), a-hydrocarbon-substituted aromatic acyloin compounds (U.S. Pat. No. 2,722,512A), polynuclear quinone compounds (U.S. Pat. Nos. 3,046,127A and 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([0065] of JP2016-27384A), and acylphosphine oxide compounds (JP1988-40799B (JP-S63-40799B), JP1993-29234B (JP-H5-29234B), JP1998-95788A (JP-H10-95788A), and JP1998-29997A (JP-H10-29997A)).

Commercially available products can also be used as such a photopolymerization initiator, and examples thereof include IRGACURE-184, IRGACURE-907, IRGACURE-369, IRGACURE-651, IRGACURE-819, IRGACURE-OXE-01, and IRGACURE-OXE-02, manufactured by BASF SE.

In a case where the liquid crystal composition described above contains a polymerization initiator, a content of the polymerization initiator is preferably 0.01% to 30% by mass and more preferably 0.1% to 15% by mass with respect to the total solid content mass of the liquid crystal composition.

### <Surfactant>

The liquid crystal composition may contain a surfactant.

The surfactant is not particularly limited, and a polymer-based surfactant or a low-molecular-weight surfactant can be used, and compounds described in paragraphs [0253] to [0293] of JP2011-237513A can be used.

In addition, as the surfactant, fluorine (meth)acrylate-based polymers, silicon-based polymers, and the like described in paragraphs [0018] to [0043] of JP2007-272185A can also be used.

In addition, examples of the interface improver include compounds described in paragraphs [0079] to [0102] of JP2007-069471A, polymerizable liquid crystal compounds represented by Formula (4) described in JP2013-047204A (particularly, compounds described in paragraphs [0020] to [0032]), polymerizable liquid crystal compounds represented by Formula (4) described in JP2012-211306A (particularly, compounds described in paragraphs [0022] to [0029]), liquid crystal alignment promoters represented by Formula (4) described in JP2002-129162A (particularly, compounds described in paragraphs [0076] to [0078] and paragraphs [0082] to [0084]), compounds represented by Formulae (4), (II), and (III) described in JP2005-099248A (particularly, compounds described in paragraphs [0092] to [0096]), compounds described in paragraphs [0013] to [0059] of JP4385997B, compounds described in paragraphs [0018] to [0044] of JP5034200B, and compounds described in paragraphs [0019] to [0038] of JP4895088B.

One kind of the surfactant may be used singly or two or more kinds thereof may be used concurrently.

In a case where the liquid crystal composition contains a surfactant, a content of the surfactant is preferably 0.005 to 15% by mass, more preferably 0.01 to 5% by mass, and still more preferably 0.015 to 3% by mass with respect to the total solid content mass of the liquid crystal composition. In a case where a plurality of surfactants are used in combination, it is preferable that the total amount of the plurality of surfactants is within the above range.

### [Method of Preparing Light Absorption Anisotropic Film]

A method of preparing the light absorption anisotropic film according to the embodiment of the present invention is not particularly limited, and examples thereof include a method including, in the following order, a step of applying the above-described liquid crystal composition (hereinafter, also referred to as “composition for forming a light absorption anisotropic film”) to form a coating film (hereinafter, also referred to as “coating film forming step”) and a step of aligning a liquid crystalline component or a dichroic substance contained in the coating film (hereinafter, also referred to as “alignment step”).

In a case where the above-described dichroic substance has liquid crystallinity, the liquid crystalline component is a component which also includes the dichroic substance having liquid crystallinity in addition to the above-described liquid crystal compound.

### <Coating Film Forming Step>

The coating film forming step is a step of applying the composition for forming a light absorption anisotropic film to form a coating film.

By using the composition for forming a light absorption anisotropic film that contains the above-described solvent, or by using a liquid-like material such as a melt obtained by heating the composition for forming a light absorption anisotropic film, it becomes easy to coat the composition for forming a light absorption anisotropic film.

Specific examples of the method of coating the film with the composition for forming a light absorption anisotropic film include known methods such as a roll coating method, a gravure printing method, a spin coating method, a wire bar coating method, an extrusion coating method, a direct gravure coating method, a reverse gravure coating method, a die coating method, a spraying method, and an ink jet method.

In the present invention, from the viewpoint of increasing the optical effect (for example, viewing angle control), the coating amount of the dichroic substance in the coating film forming step is preferably 15 mg/m² or more, more preferably 50 to 1,000 mg/m², and still more preferably 200 to 800 mg/m².

### <Alignment Step>

The aligning step is a step of aligning the liquid crystal component contained in the coating film. In this manner, the light absorption anisotropic film is obtained.

The alignment step may include a drying treatment. Components such as a solvent can be removed from the coating film by performing the drying treatment. The drying treatment may be performed using a method (for example, natural drying) of leaving the coating film to stand at room temperature for a predetermined time, or may be performed by a method of performing heating and/or blowing.

Here, the liquid crystal component contained in the composition for forming a light absorption anisotropic film may be aligned by the coating film forming step or the drying treatment described above. For example, in an embodiment in which the composition for forming a light absorption anisotropic film is prepared as a coating solution containing a solvent, a coating film having light absorption anisotropy (that is, a light absorption anisotropic film) is obtained by drying the coating film and removing the solvent from the coating film.

In a case where the drying treatment is performed at a temperature higher than or equal to a transition temperature of the liquid crystalline component contained in the coating film to the liquid crystal phase, a heat treatment described below may not be performed.

From the viewpoint of manufacturing suitability or the like, the transition temperature of the liquid crystalline component contained in the coating film to the liquid crystal phase is preferably 10° C. to 250° C. and more preferably 25° C. to 190° C. In a case where the above-described transition temperature is 10° C. or higher, a cooling treatment or the like for lowering the temperature to a temperature range in which the liquid crystal phase is exhibited is not necessary, which is preferable. In addition, in a case where the above-described transition temperature is 250° C. or lower, a high temperature is not required even in a case of setting an isotropic liquid state at a temperature higher than the temperature range in which the liquid crystal phase is temporarily exhibited, and waste of thermal energy and deformation and deterioration of a substrate can be reduced, which is preferable.

The aligning step preferably has a heating treatment.

In this manner, since the liquid crystalline component contained in the coating film can be aligned, the coating film after being subjected to the heat treatment can be suitably used as the light absorption anisotropic film.

From the viewpoint of the manufacturing suitability, the heat treatment is performed at a temperature of preferably 10° C. to 250° C. and more preferably 25° C. to 190° C. Further, the heating time is preferably 1 to 300 seconds, and more preferably 1 to 60 seconds.

The aligning step may have a cooling treatment to be performed after the heating treatment. The cooling treatment is a treatment of cooling the heated coating film to room temperature (20° C. to 25° C.). In this manner, the alignment of the liquid crystalline component contained in the coating film can be fixed. The cooling means is not particularly limited and can be performed according to a known method.

The light absorption anisotropic film can be obtained by performing the above-described steps.

In the present embodiment, examples of a method of aligning the liquid crystalline component contained in the coating film include the drying treatment and the heat treatment, but the present invention is not limited thereto, and the liquid crystalline component can be aligned by a known alignment treatment.

### <Other Steps>

The method of forming a light absorption anisotropic film may include a step of curing the light absorption anisotropic film after the above-described alignment step (hereinafter, also referred to as “curing step”).

For example, in a case where the light absorption anisotropic film has a crosslinkable group (polymerizable group), the curing step is performed by heating and/or light irradiation (exposure). Between these, it is preferable that the curing step is performed by irradiating the film with light.

Various light sources such as infrared rays, visible light, and ultraviolet rays can be used as the light source for curing, but ultraviolet rays are preferable. In addition, ultraviolet rays may be applied while the layer is heated during curing, or ultraviolet rays may be applied through a filter which transmits only a specific wavelength.

In a case where the exposure is performed while the layer is heated, the heating temperature during the exposure depends on the transition temperature of the liquid crystalline component contained in the liquid crystal film to the liquid crystal phase, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

A thickness of the light absorption anisotropic film according to the embodiment of the present invention is not particularly limited, but is preferably 1.5 m or more, more preferably 2 to 10 m, and still more preferably 2 to 8 m.

Here, the thickness of the light absorption anisotropic film is measured by cutting the light absorption anisotropic film using a microtome to prepare a sample having a cross section, observing the cross section with a scanning electron microscope from a normal direction with respect to the cross section, and measuring the thickness.

### [Laminate]

The laminate according to the embodiment of the present invention has the above-described light absorption anisotropic film according to the embodiment of the present invention.

In addition, the laminate according to the embodiment of the present invention may have at least one layer of a polarizer layer, an antireflection layer, or a phase difference layer.

### (Polarizer Layer)

The polarizer layer is not particularly limited as long as it is a member functioning to convert light into specific linearly polarized light. An absorption-type polarizer or a reflection-type polarizer which is known can be used.

An iodine-based polarizer, a dye-based polarizer using a dichroic dye, a polyene-based polarizer, or the like is used as the absorptive type polarizer. The iodine-based polarizer and the dye-based polarizer include a coating type polarizer and a stretching type polarizer, and any of these polarizers can be applied, but a coating type polarizer is preferable.

In addition, examples of a method of obtaining a polarizer by carrying out stretching and dying in a state of a laminated film in which a polyvinyl alcohol layer is formed on a base material include the methods disclosed in JP5048120B, JP5143918B, JP4691205B, JP4751481B, and JP4751486B, and known technologies relating to these polarizers can also be preferably used.

Examples of the coating type polarizer include those in WO2018/124198A, WO2018/186503A, WO2019/132020A, WO2019/132018A, WO2019/189345A, JP2019-197168A, JP2019-194685A, and JP2019-139222A, and known techniques relating to these polarizers can also be preferably used.

A polarizer in which thin films having different birefringence are laminated, a wire grid-type polarizer, a polarizer having a combination of a cholesteric liquid crystal having a selective reflection range, a ¼ wavelength plate, and the like is used as the reflective type polarizer.

Among these, from the viewpoint of more excellent adhesiveness, a polarizer including a polyvinyl alcohol-based resin (a polymer including —CH₂—CHOH— as a repeating unit, in particular, at least one selected from the group consisting of a polyvinyl alcohol and an ethylene-vinyl alcohol copolymer) is preferable.

In addition, from the viewpoint of imparting crack resistance, the polarizer may have a depolarization unit formed along the opposite end edges.

Examples of the depolarization unit include JP2014-240970A.

In addition, the polarizer may have non-polarizing parts arranged at predetermined intervals in the long-length direction and/or the width direction.

The non-polarizing part is a decolorized part which is partially decolorized.

The arrangement pattern of the non-polarizing parts can be appropriately set according to a purpose.

For example, the non-polarizing parts are arranged at a position corresponding to a camera unit of an image display device in a case where a polarizer is cut (cut, punched, or the like) to a predetermined size in order to be attached to the image display device in a predetermined size.

Examples of the arrangement pattern of the non-polarizing parts include those in JP2016-27392A.

### [Antireflection Layer]

The antireflection layer is not particularly limited, and a known antireflection layer can be used.

Examples of the antireflection layer include the antireflection layers described in paragraphs 0108 to 0121 of WO2016/047648A, the contents of which are incorporated in the present specification.

### [Retardation Layer]

The retardation layer is not particularly limited, and a known retardation layer can be used.

Examples of the retardation layer include a stretched polycarbonate film, a stretched norbornene-based polymer film, a transparent film containing aligned inorganic particles having birefringence, such as strontium carbonate, a thin film in which oblique deposition of an inorganic dielectric is performed on a support, a film in which the liquid crystal compound is uniaxially aligned and the alignment is fixed, and the like.

In addition, as the retardation layer, a film in which the above-described liquid crystal compound is uniaxially aligned and fixed is preferable.

### [Image Display Device]

The image display device according to the embodiment of the present invention has the laminate according to the embodiment of the present invention.

A display element used in the image display device according to the embodiment of the present invention is not particularly limited, and examples thereof include a liquid crystal cell, an organic electroluminescence (hereinafter, abbreviated as “EL”) display panel, an inorganic EL display panel, and a plasma display panel.

### [Viewing Angle Switching Device]

The image display device according to the embodiment of the present invention may be an image display device including the laminate according to the embodiment of the present invention and an electronically controlled field of view angle switching cell, that is, a viewable angle switchable image display device (viewing angle switching device).

By using the light absorption anisotropic film according to the embodiment of the present invention, the emission angle of light can be narrowed.

Here, various methods for the viewable angle switchable image display device are known, but the light absorption anisotropic film or the laminate according to the embodiment of the present invention can be used for the purpose of generating light having a narrow emission angle.

For example, light having a narrow emission angle is generated by using the light absorption anisotropic film or the laminate according to the embodiment of the present invention, and then the light is passed through an element that controls the presence or absence of the diffusion of light as described in JP1997-105907A (JP-H9-105907A), whereby the narrow viewable angle/wide viewable angle can be switched.

Alternatively, as described in JP2017-098246A, in a narrow viewing angle/wide viewing angle switching backlight system including, from a viewing side, a reverse prism sheet, a first light guide plate (a light emitted from the reverse prism sheet has a narrow viewing angle) to which light is incident at a relatively large incidence angle, an optical filter element which absorbs light incident obliquely and emits light at a narrow emission angle, the light being incident on the reverse prism sheet at a relatively small incidence angle, and a second light guide plate (a light emitted from the reverse prism sheet has a narrow viewing angle), the light absorption anisotropic film or the laminate according to the embodiment of the present invention can be used as the optical filter element.

In addition, in a backlight system in which, from the viewing side, a first light guide plate, an optical filter that absorbs light incident obliquely and emits light at a narrow angle, and a second light guide plate are laminated in this order, and, among the first light guide plate and the second light guide plate, the viewing angle is wide in a case where light is emitted from the first light guide plate and the viewing angle is narrow in a case where light is emitted only from the second light guide plate, the light absorption anisotropic film or the laminate according to the embodiment of the present invention can be used as the optical filter.

In addition, a phase difference modulation element such as a liquid crystal cell can be disposed between the light absorption anisotropic film according to the embodiment of the present invention and the horizontally aligned polarizer to switch between the narrow viewable angle and the wide viewable angle. For example, in a case where a liquid crystal cell in a VA mode or an ECB mode is used as a phase difference modulation cell, the viewing angle is narrow in a state in which the liquid crystal in the liquid crystal cell is vertically aligned, and the viewing angle is wide in a case where the liquid crystal in the liquid crystal cell is tilt-aligned, and the narrow viewing angle and the wide viewing angle can be controlled by the presence or absence of a voltage application to the cell.

In addition, it is also possible to use a liquid crystal cell in an IPS mode as the phase difference modulation cell. The alignment direction of the liquid crystal cell at the time of non-voltage application and the absorption axis direction of the horizontal alignment polarizer are made parallel or perpendicular to each other, and the alignment direction of the liquid crystal cell is changed by applying a voltage, so that the viewing angle can be switched from the narrow viewing angle to the wide viewing angle.

Furthermore, as the phase difference modulation cell, use of a liquid crystal cell in a twisted nematic (TN) mode is also considered. It is preferable that the liquid crystal cell is a cell in which a twisted angle (twist angle) of the alignment can be switched between 0° and 90° or between 0° and 270° by turning on and off the voltage.

In addition, in the image display device according to the embodiment of the present invention, a viewing angle of a plurality of regions in the display screen may be switched independently.

### [Optical Device/Head-Mounted Display]

The light absorption anisotropic film according to the embodiment of the present invention can be used in an optical device (head-mounted display) including a light guide plate in which a diffraction element is disposed on a surface.

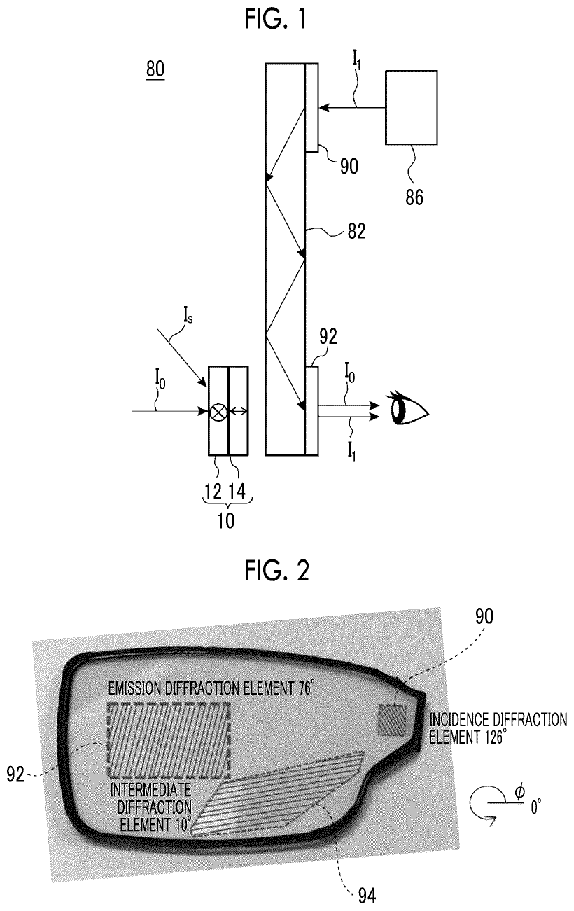

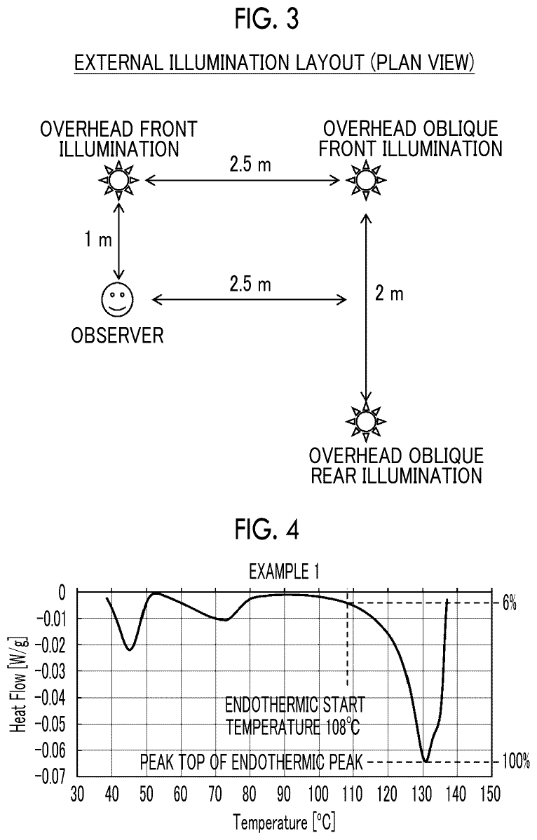

FIG. 1 shows a schematic view of an example of the head-mounted display according to the embodiment of the present invention.

A head-mounted display 80 shown in FIG. 1 is an example of an AR glass, and includes a light guide plate 82, an incidence diffraction element 90 and an emission diffraction element 92 which are arranged on one surface of the light guide plate 82, an optical filter 10, and an image display element 86. The light guide plate 82, the incidence diffraction element 90, the emission diffraction element 92, and the optical filter 10 constitute the laminate according to the embodiment of the present invention.

As shown in FIG. 1, the incidence diffraction element 90 is disposed on a surface (main surface) of the light guide plate 82 on one end part side. In addition, the emission diffraction element 92 is disposed on the surface of the light guide plate 82 on the other end part side.

The disposition position of the incidence diffraction element 90 corresponds to an incidence position of a video light I₁ from the image display element 86 to the light guide plate 82. On the other hand, the disposition position of the emission diffraction element 92 corresponds to an emission position of the video light I₁ from the light guide plate 82, that is, an observation position of the video light I₁ by the user. In addition, the incidence diffraction element 90 and the emission diffraction element 92 are arranged on the same surface of the light guide plate 82.

In addition, the optical filter 10 is disposed on a surface of the light guide plate 82, the surface facing the emission diffraction element 92 and being opposite to the surface on which the emission diffraction element 92 of the light guide plate 82 is disposed.

As shown in FIG. 1, the optical filter 10 has the same shape as the emission diffraction element 92.

An intermediate diffraction element 94 may be provided in the light guide plate 82 (see FIG. 2).

In addition, the disposition position of each diffraction element is not limited to the end part of the light guide plate, and various positions can be used depending on the shape of the light guide plate, or the like.

In the head-mounted display 80 (AR glass) having such a configuration, the video light I₁ displayed by the image display element 86 is incident into the light guide plate 82 at an angle at which the video light I₁ is diffracted by the incidence diffraction element 90 and totally reflected at an interface between the light guide plate 82 and air.

The video light I₁ incident into the light guide plate 82 is totally reflected by both surfaces of the light guide plate 82, guided inside the light guide plate 82, and incident into the emission diffraction element 92.

The video light I₁ incident into the emission diffraction element 92 is diffracted by the emission diffraction element 92 in a direction perpendicular to the surface of the emission diffraction element 92.

The video light I₁ diffracted by the emission diffraction element 92 is emitted to an observation position by the user outside the light guide plate 82 to be observed by the user.

It is preferable that the optical filter 10 and the light guide plate 82 have an air gap therebetween. In a case where there is no air gap, the video light I₁ which has advanced in the light guide plate 82 is incident on the optical filter 10, so that the video light I₁ is attenuated by absorption in a case where the video light I₁ is propagated in the optical filter 10, totally reflected on the surface of the optical filter 10 on the side opposite to the light guide plate 82, and propagated again in the optical filter 10. By providing the air gap between the optical filter 10 and the light guide plate 82, the video light I₁ from the light guide plate is not incident on the optical filter, and the above-described problem can be solved.

In addition, as shown in FIG. 1, an external light I₀ incident into the head-mounted display 80 from a front direction, that is, a background is transmitted through the optical filter 10, incident on the light guide plate 82, transmitted through the emission diffraction element 92, and reaches the observation position by the user. In the following description, the external light incident into the head-mounted display 80 from the front direction is also referred to as a front external light I₀.

As a result, the head-mounted display 80 displays a virtual video superimposed on the actual scene viewed by the user by propagating the video displayed by the image display element 86 by being incident on one end of the light guide plate 82 and being emitted from the other end.

A shape of the optical filter 10 is not limited to the same shape as the diffraction element and may be a different shape, and a size thereof may also be different. However, in order to suitably shield external light incident on the diffraction element from an oblique direction, that is, an oblique external light Iₛ, and to suppress unnecessary shielding of the background, that is, the front external light I₀, it is preferable that the diffraction element and the optical filter have the same shape and size.

The light guide plate 82 is not particularly limited, and a known light guide plate used in an image display device or the like in the related art, such as a light guide plate used in various AR glasses and a light guide plate used in a backlight unit of a liquid crystal display device, can be used.

The image display element 86 is not limited, and various known image display elements (displays) used in various image display devices such as AR glass can be used.

Examples of the image display element 86 include a liquid crystal display (including liquid crystal on silicon (LCOS)), an organic electroluminescent display, an inorganic electroluminescent display, a digital light processing (DLP), a micro-electro-mechanical systems (MEMS)-type display, and a micro light-emitting diode (LED) display.

The image display element 86 may display a monochrome image, a two-color image, or a color image.

In the optical device according to the embodiment of the present invention, an optical filter including the laminate according to the embodiment of the present invention, which covers the diffraction element, is preferably provided, and as shown in the illustrated example, an optical filter including a laminate 14 and a polarizer 12 is provided.

The optical device according to the embodiment of the present invention includes the optical filter 10 (10m) as described above, and thus, in a case of being used for a head-mounted display such as AR glass, the light transmittance in the front direction (front external light I₀) is high, that is, the visibility of the background is excellent, and rainbow-like unevenness caused by the external light (oblique external light Iₛ) incident from the front overhead (diagonally forward overhead) of the observer can be suppressed. Furthermore, with the optical device according to the embodiment of the present invention, it is preferable that not only rainbow-like unevenness caused by the external light incident from the front of the observer's head above, but also rainbow-like unevenness caused by the external light incident from the oblique front above of the observer (oblique upward direction front) can be suppressed.

In the laminate 14 constituting the optical filter 10 of the optical device according to the embodiment of the present invention, an angle between an absorption axis (alignment direction of the liquid crystal compound) and a normal direction of the laminate 14 is 0° to 45°. That is, the laminate 14 has an absorption axis extending in a normal direction of the main surface of the laminate 14 and a normal direction of the main surface of the light guide plate 82.

On the other hand, the polarizer 12 constituting the optical filter 10 is a polarizer having an absorption axis in the main surface. That is, the polarizer has an absorption axis parallel to the main surface of the laminate 14 and the main surface of the light guide plate 82.

In the present invention, in a case where the optical filter includes the laminate 14 and the polarizer 12, from the viewpoint of improving light resistance, it is preferable that the laminate 14 is disposed on the light guide plate 82 side.

### EXAMPLES

Hereinbelow, the present invention will be described in more detail with reference to Examples. The materials, the amounts of materials used, the ratios, the treatment details, the treatment procedure, or the like shown in the following Examples can be appropriately modified without departing from the spirit of the present invention. Therefore, the range of the present invention will not be restrictively interpreted by the following examples.

### Example 1

### (1) Temporary Support

A cellulose acylate film 1 (TAC base material having a thickness of 60 m; FUJITAC TG60UL, manufactured by FUJIFILM Corporation) was used as a temporary support after the surface thereof was saponified with an alkali solution.

### (2) Preparation of Alignment Film

The composition 1 for forming an alignment film, having the following composition, was applied to the cellulose acylate film 1. The support on which the coating film was formed was dried with hot air at 145° C. for 120 seconds to form an alignment film 1. The film thickness of the alignment film 1 was 0.5 μm.

Composition 1 for Forming Alignment Film

| | | |
|---|---|---|
| Polymer PA-1 shown below | 10.0 | parts by mass |
| Acid generator PAG-1 shown below | 0.83 | parts by mass |
| Stabilizer DIPEA shown below | 0.06 | parts by mass |
| Butyl acetate | 100 | parts by mass |
| Methyl ethyl ketone | 25 | parts by mass |

Polymer PA-1 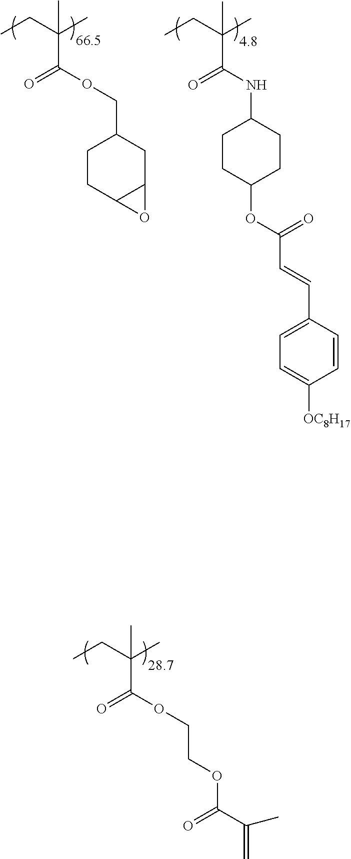
Acid generator PAG-1 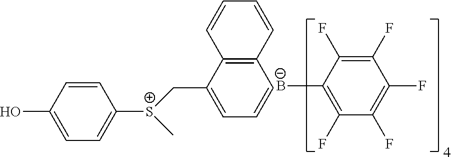
Stabilizer DIPEA

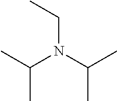

### (3) Preparation of Light Absorption Anisotropic Film

The composition 1 for forming a light absorption anisotropic film having the following composition was applied onto the obtained TAC (triacetyl cellulose) film with the alignment film using a wire bar, and heated at 120° C. for 60 seconds and cooled to 35° C. Next, the coating layer was heated at 75° C. for 60 seconds and cooled to room temperature again.

Thereafter, the film was irradiated with a light emitting diode (LED) lamp (central wavelength: 365 nm) for 2 seconds under a nitrogen purge condition (oxygen concentration: 100 ppm or less) in an irradiation condition of an illuminance of 200 mW/cm² from the film normal direction, thereby preparing a light absorption anisotropic film 1 on the alignment film 1. The film thickness of the light absorption anisotropic film 1 was 4.5 μm.

Composition for forming light absorption anisotropic film 1

| | | |
|---|---|---|
| Dichroic substance D-1 shown below | 0.91 | parts by mass |
| Dichroic substance D-2 shown below | 0.22 | parts by mass |
| Dichroic substance D-3 shown below | 1.49 | parts by mass |
| Polymer liquid crystal compound P-1 shown below | 8.15 | parts by mass |
| Low-molecular-weight liquid crystal compound L-1 shown below | 1.85 | parts by mass |
| IRGACURE OXE-2 (manufactured by BASF SE) shown below | 0.20 | parts by mass |
| Vertical alignment agent E-1 shown below | 0.16 | parts by mass |
| Vertical alignment agent E-2 shown below | 0.16 | parts by mass |
| Surfactant F-1 shown below | 0.007 | parts by mass |
| Cyclopentanone | 78.17 | parts by mass |
| Benzyl alcohol | 8.69 | parts by mass |

Dichroic substance D-1 (maximal absorption wavelength: 410 nm) 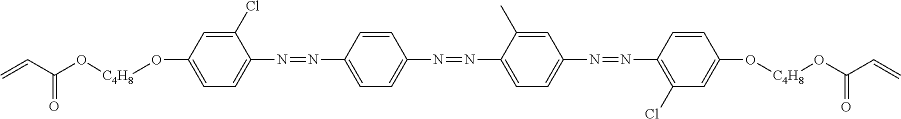
Dichroic substance D-2 (maximal absorption wavelength: 455 nm) 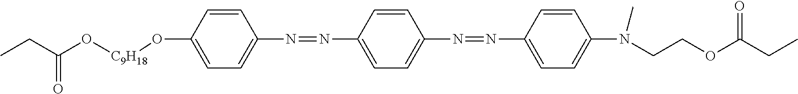
Dichroic substance D-3 (maximal absorption wavelength: 612 nm) 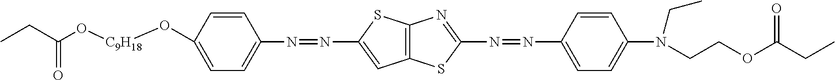
Polymer liquid crystal compound P-1 (weight-average molecular weight: 20,000) 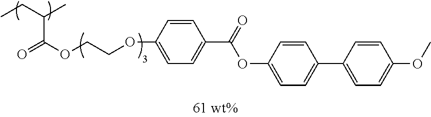 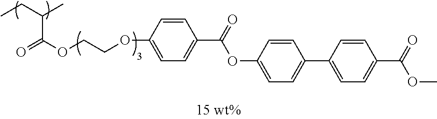 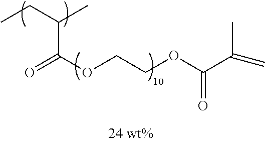
Low-molecular-weight liquid crystal compound L-1 [mixture of the following liquid crystal compounds (RA), (RB), and (RC) at a mass ratio of 84:14:2] 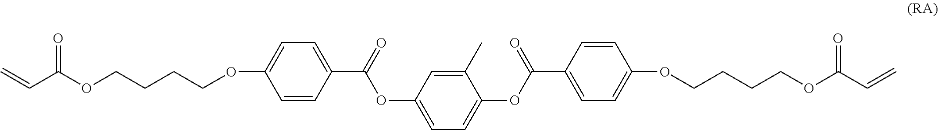 [SMILES: C=CC(=O)OCCCCOc1ccc(C(=O)Oc2ccc(OC(=O)c3ccc(OCCCCOC(=O)C=C)cc3)c(C)c2)cc1] 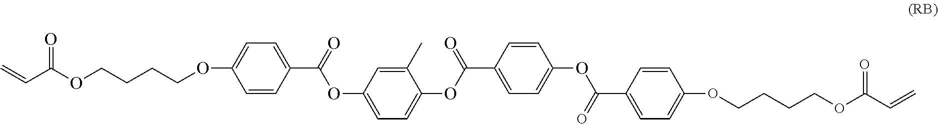 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1] 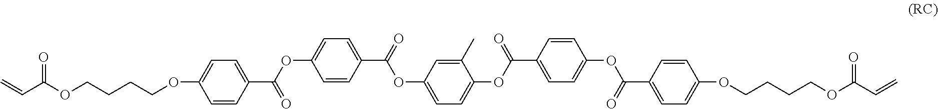 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Vertical Alignment Agent E-1 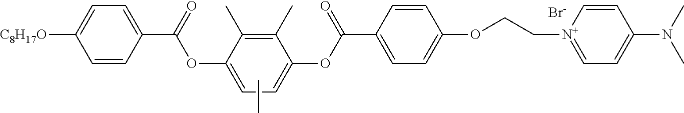
Vertical Alignment Agent E-2 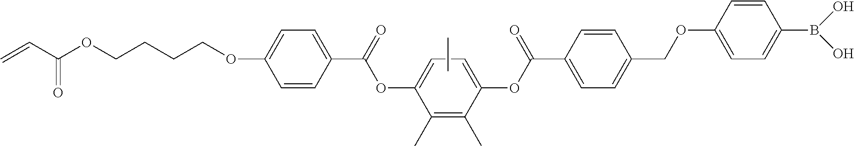
Surfactant F-1 [in the following formula, the numerals indicate the content (% by mass) of each repeating unit with respect to all repeating units, and TMS represents a trimethylsilyl group] (weight-average molecular weight: 28,500)

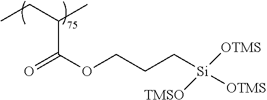

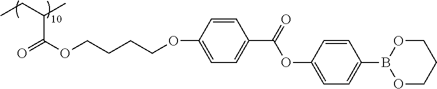

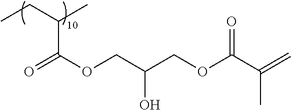

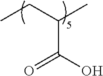

### (4) Preparation of Protective Layer

The surface of the obtained light absorption anisotropic film 1 was subjected to a corona treatment under the conditions of 4.0 m/min, 440 W, and a clearance of 2.0 mm.

Next, a coating liquid 1 for forming a protective layer having the following composition was applied onto the light absorption anisotropic film 1 after the corona treatment with a wire bar to form a coating film.

Next, the temporary support on which the coating film was formed was dried with hot air at 60° C. for 60 seconds and further dried with hot air at 100° C. for 120 seconds to form a protective layer 1.

Thereafter, the film was irradiated with an LED lamp (central wavelength: 365 nm) for 2 seconds under a nitrogen purge condition (oxygen concentration: 100 ppm or less) in an irradiation condition of an illuminance of 200 mW/cm² from the film normal direction, thereby forming the protective layer 1 on the light absorption anisotropic film 1 to prepare a light absorption anisotropic film 1 (layer structure: temporary support 1/alignment film 1/light absorption anisotropic film 1/protective layer 1). A film thickness of the protective layer 1 was 0.5 km.

Protective layer coating liquid formulation 1

| | | |
|---|---|---|
| Modified polyvinyl alcohol PVA-1 shown below | 3.80 | parts by mass |
| IRGACURE 2959 (manufactured by BASF SE) | 0.20 | parts by mass |
| Coloring agent compound G-1 shown below | 0.08 | parts by mass |
| Water | 70 | parts by mass |
| Methanol | 30 | parts by mass |

Modified polyvinyl alcohol PVA-1 [in the following formula, the numbers indicate the content (% by mass) of each repeating unit with respect to all repeating units.] (polymerization degree: 1700) 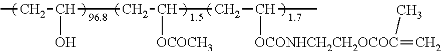
Coloring agent compound G-1

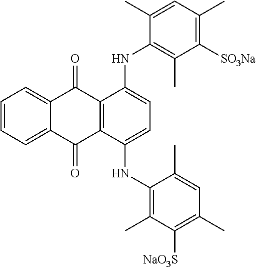

### Example 2

A light absorption anisotropic film 2 (layer structure: temporary support 1/alignment film 1/light absorption anisotropic film 2/protective layer 1) was prepared in the same manner as in Example 1, except that a light absorption anisotropic film 2 prepared by using a composition 2 for forming a light absorption anisotropic film having the following composition instead of the composition 1 for forming a light absorption anisotropic film was used.

Composition for forming light absorption anisotropic film 2

| | | |
|---|---|---|
| Dichroic substance D-1 shown above | 0.91 | parts by mass |
| Dichroic substance D-2 shown above | 0.22 | parts by mass |
| Dichroic substance D-3 shown above | 1.49 | parts by mass |
| Polymer liquid crystal compound P-2 shown below | 8.15 | parts by mass |
| Low-molecular-weight liquid crystal compound L-1 shown above | 1.85 | parts by mass |
| IRGACURE OXE-2 (manufactured by BASF SE) | 0.20 | parts by mass |
| Alignment agent E-1 shown above | 0.16 | parts by mass |
| Alignment agent E-2 shown above | 0.16 | parts by mass |
| Surfactant F-1 shown above | 0.007 | parts by mass |
| Cyclopentanone | 78.17 | parts by mass |
| Benzyl alcohol | 8.69 | parts by mass |

Polymer liquid crystal compound P-2 (weight-average molecular weight: 21,000)

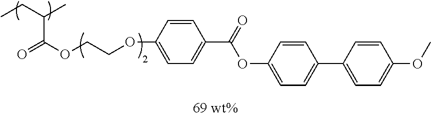

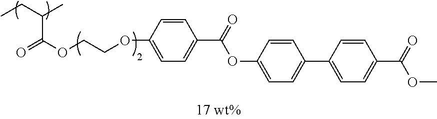

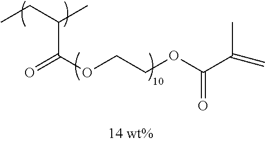

### Example 3

A light absorption anisotropic film 3 (layer structure: temporary support 1/alignment film 1/light absorption anisotropic film 3/protective layer 1) was prepared in the same manner as in Example 1, except that a light absorption anisotropic film 3 prepared by using a composition 3 for forming a light absorption anisotropic film having the following composition instead of the composition 1 for forming a light absorption anisotropic film was used.

Composition for forming light absorption anisotropic film 3

| | | |
|---|---|---|
| Dichroic substance D-1 shown above | 0.91 | parts by mass |
| Dichroic substance D-2 shown above | 0.22 | parts by mass |
| Dichroic substance D-3 shown above | 1.49 | parts by mass |
| Polymer liquid crystal compound P-3 shown below | 8.15 | parts by mass |
| Low-molecular-weight liquid crystal compound L-1 shown above | 1.85 | parts by mass |
| IRGACURE OXE-2 (manufactured by BASF SE) | 0.20 | parts by mass |
| Alignment agent E-1 shown above | 0.16 | parts by mass |
| Alignment agent E-2 shown above | 0.16 | parts by mass |
| Surfactant F-1 shown above | 0.007 | parts by mass |
| Cyclopentanone | 78.17 | parts by mass |
| Benzyl alcohol | 8.69 | parts by mass |

Polymer liquid crystal compound P-3 (weight-average molecular weight: 19,000)

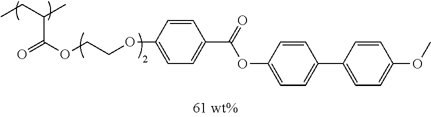

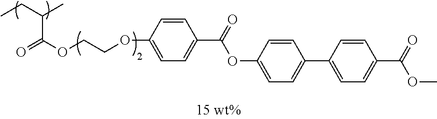

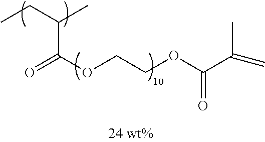

### Comparative Example 1

A light absorption anisotropic film H1 (layer structure: temporary support i/alignment film 1/light absorption anisotropic film H1/protective layer 1) was prepared in the same manner as in Example 1, except that a light absorption anisotropic film H1 prepared by using a composition H1 for forming a light absorption anisotropic film having the following composition instead of the composition 1 for forming a light absorption anisotropic film was used.

Composition H1 for forming light absorption anisotropic film

| | | |
|---|---|---|
| Dichroic substance D-4 shown below | 0.91 | parts by mass |
| Dichroic substance D-2 shown above | 0.22 | parts by mass |
| Dichroic substance D-3 shown above | 1.49 | parts by mass |
| Polymer liquid crystal compound P-1 shown above | 8.15 | parts by mass |
| Low-molecular-weight liquid crystal compound L-1 shown above | 1.85 | parts by mass |
| IRGACURE OXE-2 (manufactured by BASF SE) | 0.20 | parts by mass |
| Alignment agent E-1 shown above | 0.16 | parts by mass |
| Alignment agent E-2 shown above | 0.16 | parts by mass |
| Surfactant F-1 shown above | 0.007 | parts by mass |
| Cyclopentanone | 78.17 | parts by mass |
| Benzyl alcohol | 8.69 | parts by mass |

Dichroic substance D-4 (maximal absorption wavelength: 418 nm)

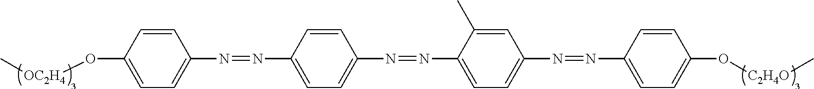

### Comparative Example 2

Alight absorption anisotropic film H2 (layer structure: temporary support 1/alignment film 1/light absorption anisotropic film H2/protective layer 1) was prepared in the same manner as in Example 1, except that a light absorption anisotropic film H2 prepared by using a composition H2 for forming a light absorption anisotropic film having the following composition instead of the composition 1 for forming a light absorption anisotropic film was used.

Composition H2 for forming light absorption anisotropic film

| | | |
|---|---|---|
| Dichroic substance D-5 shown below | 0.63 | parts by mass |
| Dichroic substance D-2 shown above | 0.17 | parts by mass |
| Dichroic substance D-3 shown above | 1.13 | parts by mass |
| Polymer liquid crystal compound P-1 shown above | 8.18 | parts by mass |
| IRGACURE OXE-2 (manufactured by BASF SE) | 0.16 | parts by mass |
| Alignment agent E-1 shown above | 0.13 | parts by mass |
| Alignment agent E-2 shown above | 0.13 | parts by mass |
| Surfactant F-2 shown below | 0.004 | parts by mass |
| Cyclopentanone | 85.01 | parts by mass |
| Benzyl alcohol | 4.47 | parts by mass |

Dichroic substance D-5 (maximal absorption wavelength: 415 nm)
Embedded image 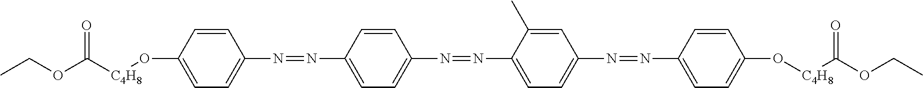
Surfactant F-2 [in the following formula, the numbers indicate the content (% by mass) of each repeating unit with respect to all repeating units.] (weight-average molecular weight: 16,000)

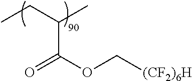

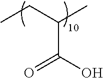

### Comparative Example 3

A light absorption anisotropic film H3 (layer structure: temporary support 1/alignment film 1/light absorption anisotropic film H3/protective layer 1) was prepared in the same manner as in Example 1, except that a light absorption anisotropic film H3 prepared by using a composition H3 for forming a light absorption anisotropic film having the following composition instead of the composition 1 for forming a light absorption anisotropic film was used.

Composition H3 for forming light absorption anisotropic film

| | | |
|---|---|---|
| Dichroic substance D-5 shown above | 0.91 | parts by mass |
| Dichroic substance D-2 shown above | 0.22 | parts by mass |
| Dichroic substance D-3 shown above | 1.49 | parts by mass |
| Polymer liquid crystal compound P-1 | 8.15 | parts by mass |
| shown above | | |
| Low-molecular-weight liquid crystal | 1.85 | parts by mass |
| compound L-1 shown above | | |
| IRGACURE OXE-2 (manufactured by BASF SE) | 0.20 | parts by mass |
| Alignment agent E-1 shown above | 0.16 | parts by mass |
| Alignment agent E-2 shown above | 0.16 | parts by mass |
| Surfactant F-1 shown above | 0.007 | parts by mass |
| Cyclopentanone | 78.17 | parts by mass |
| Benzyl alcohol | 8.69 | parts by mass |

In a case where the transmittance central axis angle θ of the light absorption anisotropic film prepared in Examples 1 to 3 and Comparative Examples 1 to 3 was measured by the above-described method, the transmittance central axis angle θ was 0° in all cases.

### [Evaluation]

### (1) Physical Property Value

From the obtained light absorption anisotropic film, the light absorption anisotropic layer was shaved off, and DSC was performed by the above-described method to measure the endothermic start temperature of an endothermic peak derived from the dichroic substance and the maximum endothermic peak temperature of the matrix. The results are shown in Table 1 below. As described above, FIG. 4 shows the DSC curve of the light absorption anisotropic film prepared in Example 1, FIG. 5 shows the DSC curve of the light absorption anisotropic film prepared in Comparative Example 1, and FIG. 6 shows the DSC curve of only the matrix included in the light absorption anisotropic film prepared in Example 1 and Comparative Example 1.

In addition, the Δ log P value of the dichroic substance and the matrix was calculated by the above-described method. The results are shown in Table 1 below.

### (2) Alignment Degree

The alignment degree of the obtained light absorption anisotropic film at wavelengths of 450 nm and 550 nm was calculated by the following method.

In the measurement, the Mueller matrix at a wavelength of 450 nm and 550 nm at each polar angle was measured while the polar angle which was the angle with respect to the normal direction of the light-absorbing anisotropic layer was changed from −70° to 70° at intervals of 1° using AxoScan OPMF-1 (manufactured by Opto Science, Inc.), and the minimum transmittance (Tmin) was derived.

Next, after removal of the influence of surface reflection, Tmin at a polar angle at which Tmin was highest was defined as Tm(0), and Tmin in a direction in which the polar angle was further increased by 40° from the polar angle at which Tmin was highest was defined as Tm(40).

The absorbance(A) was calculated by the following expression based on the obtained Tm(0) and Tm(40), and A(0) and A(40) were calculated.

$$A = - log ( Tm )$$

Here, Tm represents a transmittance and A represents an absorbance.

The alignment degree (S(450)) at a wavelength of 450 nm and the alignment degree (S(550)) at a wavelength of 550 nm, which are defined by the following expression, were calculated from the calculated A(0) and A(40). The results are shown in Table 1 below. In a case where S(450 nm) is 0.90 or more, the alignment degree can be evaluated as being high.

$$S = ( 4.6 \times A ( 40 ) - A ( 0 ) ) / ( 4.6 \times A ( 40 ) + 2 \times A ( 0 ) )$$

### (3) Haze Value

The haze value of the light absorption anisotropic film prepared in Examples 1 to 3 and Comparative Examples 1 to 3 was measured using a haze meter (NDH2000, manufactured by Nippon Denshoku Industries Co., Ltd.) in an environment of 25° C. and a relative humidity of 55%. The results are shown in Table 1 below. The haze value was measured using each light absorption anisotropic film prepared with n=3, and the average value thereof was defined as the haze value. In addition, the measurement was performed such that the light was incident from the temporary support side. In addition, in a case where the haze value is 0.50% or less, the haze value can be evaluated as being low.

TABLE 1

| | Main material | | | | | Endothermic | | ΔlogP | | | |
|---|---|---|---|---|---|---|---|---|---|---|---|
| | | | | | Low- | start | | value | | | |
| | | | | | molecular- | temperature of | Maximum | between | | | |
| | | | | Polymer | weight | endothermic | endothermic | dichroic | Evaluation | | |
| | | | | liquid | liquid | peak derived | peak | substance | Alignment | | |
| | | | | crystal | crystal | from dichroic | temperature | and | degree | | Haze |
| | Dichroic substance | | | compound | compound | substance | of matrix | matrix | S(450) | S(550) | value |
| Example 1 | Dichroic | Dichroic | Dichroic | Polymer | Low- | 108° C. | 74° C. | 5.4 | 0.91 | 0.95 | 0.50% |
| | substance | substance | substance | liquid | molecular- | | | | | | |
| | D-1 | D-2 | D-3 | crystal | weight | | | | | | |
| | | | | compound | liquid | | | | | | |
| | | | | P-1 | crystal | | | | | | |
| | | | | | compound | | | | | | |
| | | | | | L-1 | | | | | | |
| Example 2 | Dichroic | Dichroic | Dichroic | Polymer | Low- | 108° C. | 108° C. | 5.1 | 0.92 | 0.96 | 0.40% |
| | substance | substance | substance | liquid | molecular- | (* estimated | | | | | |
| | D-1 | D-2 | D-3 | crystal | weight | from Example 1) | | | | | |
| | | | | compound | liquid | | | | | | |
| | | | | P-2 | crystal | | | | | | |
| | | | | | compound | | | | | | |
| | | | | | L-1 | | | | | | |
| Example 3 | Dichroic | Dichroic | Dichroic | Polymer | Low- | 108° C. | 109° C. | 5.0 | 0.92 | 0.96 | 0.40% |
| | substance | substance | substance | liquid | molecular- | (* estimated | | | | | |
| | D-1 | D-2 | D-3 | crystal | weight | from Example 1) | | | | | |
| | | | | compound | liquid | | | | | | |
| | | | | P-3 | crystal | | | | | | |
| | | | | | compound | | | | | | |
| | | | | | L-1 | | | | | | |
| Comparative | Dichroic | Dichroic | Dichroic | Polymer | Low- | 101° C. | 74° C. | 6.0 | 0.77 | 0.81 | 1.50% |
| Example 1 | substance | substance | substance | liquid | molecular- | | | | | | |
| | D-4 | D-2 | D-3 | crystal | weight | | | | | | |
| | | | | compound | liquid | | | | | | |
| | | | | P-1 | crystal | | | | | | |
| | | | | | compound | | | | | | |
| | | | | | L-1 | | | | | | |
| Comparative | Dichroic | Dichroic | Dichroic | Polymer | — | 103° C. | 74° C. | 6.2 | 0.88 | 0.93 | 0.70% |
| Example 2 | substance | substance | substance | liquid | | | | | | | |
| | D-5 | D-2 | D-3 | crystal | | | | | | | |
| | | | | compound | | | | | | | |
| | | | | P-1 | | | | | | | |
| Comparative | Dichroic | Dichroic | Dichroic | Polymer | Low- | 103° C. | 74° C. | 5.7 | 0.89 | 0.94 | 0.70% |
| Example 3 | substance | substance | substance | liquid | molecular- | | | | | | |
| | D-5 | D-2 | D-3 | crystal | weight | | | | | | |
| | | | | compound | liquid | | | | | | |
| | | | | P-1 | crystal | | | | | | |
| | | | | | compound | | | | | | |
| | | | | | L-1 | | | | | | |

* Estimated from Example 1 because the endothermic peaks of the dichroic substance and the matrix overlap

From the results shown in Table 1, it was found that in a case where the endothermic start temperature of the endothermic peak derived from the dichroic substance, which is observed by DSC, is lower than 105° C., the alignment degree is low and the haze value is also high (Comparative Examples 1 to 3).

On the other hand, it was found that in a case where the endothermic start temperature of the endothermic peak derived from the dichroic substance, which is observed by DSC, is 105° C. or higher, the alignment degree is high and the haze value is also low (Examples 1 to 3).

In particular, from the comparison between Examples 1 to 3, it was found that in a case where the maximum endothermic peak temperature of the matrix is 108° C. or higher, the haze value is further reduced.

### EXPLANATION OF REFERENCES

10: optical filter
12: polarizer
14: laminate
80: head-mounted display
82: light guide plate
90: incidence diffraction element
92: emission diffraction element
94: intermediate diffraction element
I₀: front external light
I₁: video light
Iₛ: oblique external light

What is claimed is:

1. Alight absorption anisotropic film comprising:
a dichroic substance; and
a matrix consisting of all components other than the dichroic substance,
wherein at least one endothermic peak derived from the dichroic substance is observed by differential scanning calorimetry, and all of the endothermic peaks are endothermic peaks having an endothermic start temperature of 105° C. or higher,
where the endothermic start temperature is a temperature at which a heat flow is 6% in a case where a heat flow at a peak top of the endothermic peak is set to 100% in a differential scanning calorimetry curve in which a vertical axis is a heat flow and a horizontal axis is a temperature, the temperature being lower than a temperature of the peak top of the endothermic peak.

2. The light absorption anisotropic film according to claim 1,
wherein at least one endothermic peak derived from the matrix is observed by differential scanning calorimetry, and a peak top of an endothermic peak showing a maximum heat flow among the endothermic peaks is observed in a temperature range of 108° C. or higher.

3. The light absorption anisotropic film according to claim 1,
wherein an absolute value of a difference between a log P value of the dichroic substance and a log P value of the matrix is 4.8 to 5.8.

4. The light absorption anisotropic film according to claim 1,
wherein an angle θ between a transmittance central axis of the light absorption anisotropic film and a normal direction of a surface of the light absorption anisotropic film is 0° or more and 450 or less.

5. The light absorption anisotropic film according to claim 1,
wherein the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.

6. A laminate comprising:
the light absorption anisotropic film according to claim 1.

7. The light absorption anisotropic film according to claim 2,
wherein an absolute value of a difference between a log P value of the dichroic substance and a log P value of the matrix is 4.8 to 5.8.

8. The light absorption anisotropic film according to claim 2,
wherein an angle θ between a transmittance central axis of the light absorption anisotropic film and a normal direction of a surface of the light absorption anisotropic film is 0° or more and 450 or less.

9. The light absorption anisotropic film according to claim 2,
wherein the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.

10. A laminate comprising:
the light absorption anisotropic film according to claim 2.

11. The light absorption anisotropic film according to claim 3,
wherein an angle θ between a transmittance central axis of the light absorption anisotropic film and a normal direction of a surface of the light absorption anisotropic film is 0° or more and 450 or less.

12. The light absorption anisotropic film according to claim 3,
wherein the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.

13. A laminate comprising:
the light absorption anisotropic film according to claim 3.

14. The light absorption anisotropic film according to claim 4,
wherein the dichroic substance is a mixture containing at least a coloring agent compound having a maximal absorption wavelength in a wavelength range of 380 nm or more and less than 455 nm, a coloring agent compound having a maximal absorption wavelength in a wavelength range of 455 nm or more and less than 560 nm, and a coloring agent compound having a maximal absorption wavelength in a wavelength range of 560 nm or more and 700 nm or less.

15. A laminate comprising:
the light absorption anisotropic film according to claim 4.

16. A laminate comprising:
the light absorption anisotropic film according to claim 5.
